(19) United States
(12) Patent Application Publication
(10) Pub. No.: US 2015/0057870 A1
(43) Pub. Date: Feb. 26, 2015

(54) PARKING ASSIST APPARATUS AND PARKING ASSIST METHOD THEREOF

(71) Applicant: MANDO CORPORATION, Pyeongtaek-si (KR)

(72) Inventor: Yoon-Hyung LEE, Seongnam-Si (KR)

(21) Appl. No.: 14/308,656

(22) Filed: Jun. 18, 2014

(30) Foreign Application Priority Data
Aug. 23, 2013 (KR) 10-2013-0100070

(51) Int. Cl. B60W 30/06

(52) U.S. Cl. CPC B60W 30/06
USPC 701/23

(57) ABSTRACT

A parking assist apparatus includes a detection unit that detects access information on door open with a current object provided at a parking line when parking a vehicle at the parking line, a control unit that receives the access information on door open with the current object detected in the detection unit, and includes a range of access information on door open with a reference object set in advance and parking assist line information, a determination unit that determines whether the access information on door open with the current object detected in the detection unit is in the range of access information on door open with the reference object in accordance with control of the control unit, and a parking operation unit that automatically parks the vehicle at a parking assist line corresponding to parking line information for enabling the door of the vehicle to be opened.

### CROSS-REFERENCE TO RELATED APPLICATION

This application claims the benefit of Korean Patent Application No. P2013-0100070, filed on Aug. 23, 2013 in the Korean Intellectual Property Office, the disclosure of which is incorporated herein by reference.

### BACKGROUND

1. Field

Embodiments of the present invention relate to a parking assist apparatus and a parking assist method thereof.

2. Description of the Related Art

In general, a conventional parking assist apparatus has been provided in such a manner that parking is performed within parking lines while considering a contact with a current object.

In such a conventional parking assist apparatus, parking is performed in a right angled parking scheme or a parallel parking scheme when parking is performed with at the parking lines.

However, in the conventional parking assist apparatus, whether a door opens (“door opens” is hereinafter referred to as a “door open”) with the current object provided with at the parking lines is possible after parking cannot be determined, and therefore a passenger has to discern whether the door open with the current object is possible when getting out of the vehicle.

Thus, in recent years, research on an improved parking assist apparatus and method which may suppress an increase in maintenance costs by preventing damage to the doors of the vehicle in advance while providing convenience to the passenger when the passenger gets out of the vehicle by making the passenger recognize whether the door opens with the current object is possible after parking has been continuously conducted.

### SUMMARY

Therefore, it is an aspect of the present invention to provide a parking assist apparatus in which door open with a current object is possible after parking a vehicle, thereby suppressing an increase in maintenance costs by preventing damage to a door unit of the vehicle in advance, and a parking assist method thereof.

It is another aspect of the present invention to provide a parking assist apparatus in which door open with a current object is possible after parking a vehicle, thereby providing convenience to a passenger when the passenger gets out of the vehicle, and a parking assist method thereof.

Additional aspects of the invention will be set forth in part in the description which follows and, in part, will be obvious from the description, or may be learned by practice of the invention.

In accordance with one aspect of the present invention, a parking assist apparatus includes: a detection unit that detects access information on door open with a current object provided at a parking line when parking a vehicle at the parking line; a control unit that receives the access information on door open with the current object detected in the detection unit, and includes a range of access information on door open with a reference object set in advance and parking assist line information for enabling a door of the vehicle to be opened; a determination unit that determines whether the access information on door open with the current object detected in the detection unit is in the range of access information on door open with the reference object in accordance with control of the control unit; and a parking operation unit that automatically parks the vehicle at a parking assist line corresponding to parking line information for enabling the door of the vehicle to be opened in accordance with the control of the control unit so that door open with the current object is possible, when it is determined in the determination unit that the access information on door open with the current object is in the range of access information on door open with the reference object.

In accordance with another aspect of the present invention, a parking assist apparatus includes: a detection unit that detects access information on door open with a current object provided at a parking line when parking a vehicle at the parking line; a control unit that receives the access information on door open with the current object detected in the detection unit, and includes a range of access information on door open with a reference object set in advance and parking assist line information for enabling a door of the vehicle to be opened; a determination unit that determines whether the access information on door open with the current object detected in the detection unit is in the range of access information on door open with the reference object in accordance with control of the control unit; a display unit that displays parking line information for enabling a door of the vehicle to be opened on a screen in accordance with the control of the control unit so that door open with the current object is possible, when it is determined in the determination unit that the access information on door open with the current object is in the range of access information on door open with the reference object; and a parking operation unit that identifies the parking line information for enabling the door to be opened displayed in the display unit, and parks the vehicle close to a parking assist line corresponding to the parking line information for enabling the door to be opened in accordance with the control of the control unit based on an intention of a driver.

Here, the determination unit may determine whether a door open access distance with the current object corresponding to the access information on door open with the current object is in a range of a door open access distance with the reference object corresponding to the range of access information on door open with the reference object in accordance with the control of the control unit.

Also, the parking assist apparatus may further include a first identification unit that identifies that the door cannot be currently opened when it is determined in the determination unit that the access information on door open with the current object is in the range of access information on door open with the reference object.

Also, the parking assist apparatus may further include a second identification unit that identifies that the vehicle is automatically parked at the parking assist line corresponding to the parking line information for enabling the door to be opened when it is determined in the determination unit that the access information on door open with the current object is in the range of access information on door open with the reference object.

Also, the parking assist apparatus may further include a third identification unit that identifies that the door can be currently opened when parking of the vehicle at the parking assist line corresponding to the parking line information for enabling the door to be opened is automatically completed in accordance with the control of the control unit by the parking operation unit.

Also, the parking assist apparatus may further include a fourth identification unit that identifies that the door can be currently opened when parking of the vehicle close to the parking assist line corresponding to the parking line information for enabling the door to be opened is completed in accordance with the control of the control unit based on the intention of the driver by the parking operation unit.

In accordance with still another aspect of the present invention, a parking assist method includes: detecting, by a detection unit, access information on door open with a current object provided at a parking line when parking a vehicle at the parking line; determining, by a determination unit, whether the access information on door open with the current object detected by the detection unit is in a range of access information on door open with a reference object set in a control unit in accordance with control of the control unit; and automatically parking, by a parking operation unit, the vehicle at a parking assist line corresponding to parking line information for enabling a door of the vehicle to be opened in accordance with the control of the control unit so that door open with the current object is possible, when it is determined in the determination unit that the access information on door open with the current object is in the range of access information on door open with the reference object.

In accordance with yet another aspect of the present invention, a parking assist method includes: detecting, by a detection unit, access information on door open with a current object provided at a parking line when parking a vehicle at the parking line; determining, by a determination unit, whether the access information on door open with the current object detected by the detection unit is in a range of access information on door open with a reference object set in a control unit in accordance with control of the control unit; displaying, by a display unit, parking line information for enabling a door of the vehicle to be opened on a screen in accordance with the control of the control unit so that door open with the current object is possible, when it is determined in the determination unit that the access information on door open with the current object is in the range of access information on door open with the reference object; and identifying, a parking operation unit, the parking line information for enabling the door to be opened displayed in the display unit, and parking the vehicle close to a parking assist line corresponding to the parking line information for enabling the door to be opened in accordance with the control of the control unit based on an intention of a driver.

Here, the determining may include determining, by the determination unit, whether a door open access distance with the current object corresponding to the access information on door open with the current object is in a range of a door open access distance with the reference object corresponding to the range of access information on door open with the reference object in accordance with the control of the control unit.

Also, after the determining, the parking assist method may further include identifying, by a first identification unit, that the door cannot be currently opened when it is determined in the determination unit that the access information on door open with the current object is in the range of access information on door open with the reference object.

Also, after the determining, the parking assist method may further include identifying, by a second identification unit, that the vehicle is automatically parked at the parking assist line corresponding to the parking line information for enabling the door to be opened when it is determined in the determination unit that the access information on door open with the current object is in the range of access information on door open with the reference object.

Also, after the automatic parking, the parking assist method may further include identifying, by a third identification unit, that the door can be currently opened when parking of the vehicle at the parking assist line corresponding to the parking line information for enabling the door to be opened is automatically completed in accordance with the control of the control unit by the parking operation unit.

Also, after the automatic parking, the parking assist method may further include identifying, by a fourth identification unit, that the door can be currently opened when parking of the vehicle close to the parking assist line corresponding to the parking line information for enabling the door to be opened is completed in accordance with the control of the control unit based on the intention of the driver by the parking operation unit.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a block configuration view showing a parking assist apparatus in accordance with a first embodiment of the present invention;

FIG. 2 is a partial perspective view showing an example of a process of detecting access information on door open with a current object in a detection unit shown in FIG. 1;

FIG. 3 is a partial plan view showing an example of a process of automatically parking a vehicle at a parking assist line corresponding to parking line information for enabling a door to be opened in a state in which parking assist line information for enabling a door to be opened is set in a control unit shown in FIG. 1;

FIG. 4 is a flowchart showing a parking assist method of a parking assist apparatus in accordance with a first embodiment of the present invention;

FIG. 5 is a flowchart showing an example of a parking assist method of a parking assist apparatus in accordance with a first embodiment of the present invention;

FIG. 6 is a block configuration view showing a parking assist apparatus in accordance with a second embodiment of the present invention;

FIG. 7 is a flowchart showing a parking assist method of a parking assist apparatus in accordance with a second embodiment of the present invention;

FIG. 8 is a flowchart showing an example of a parking assist method of a parking assist apparatus in accordance with a second embodiment of the present invention;

FIG. 9 is a block configuration view showing a parking assist apparatus in accordance with a third embodiment of the present invention;

FIG. 10 is a flowchart showing a parking assist method of a parking assist apparatus in accordance with a third embodiment of the present invention;

FIG. 11 is a flowchart showing an example of a parking assist method of a parking assist apparatus in accordance with a third embodiment of the present invention;

FIG. 12 is a block configuration view showing a parking assist apparatus in accordance with a fourth embodiment of the present invention;

FIG. 13 is a flowchart showing a parking assist method of a parking assist apparatus in accordance with a fourth embodiment of the present invention;

FIG. 14 is a flowchart showing an example of a parking assist method of a parking assist apparatus in accordance with a fourth embodiment of the present invention;

FIG. 15 is a block configuration view showing a parking assist apparatus in accordance with a fifth embodiment of the present invention;

FIG. 16 is a partial plan view showing an example of a process of displaying parking line information for enabling a door to be opened on a screen in a display unit shown in FIG. 15;

FIG. 17 is a flowchart showing a parking assist method of a parking assist apparatus in accordance with a fifth embodiment of the present invention;

FIG. 18 is a flowchart showing an example of a parking assist method of a parking assist apparatus in accordance with a fifth embodiment of the present invention;

FIG. 19 is a block configuration view showing a parking assist apparatus in accordance with a sixth embodiment of the present invention;

FIG. 20 is a flowchart showing a parking assist method of a parking assist apparatus in accordance with a sixth embodiment of the present invention;

FIG. 21 is a flowchart showing an example of a parking assist method of a parking assist apparatus in accordance with a sixth embodiment of the present invention;

FIG. 22 is a block configuration view showing a parking assist apparatus in accordance with a seventh embodiment of the present invention;

FIG. 23 is a flowchart showing a parking assist method of a parking assist apparatus in accordance with a seventh embodiment of the present invention; and

FIG. 24 is a flowchart showing an example of a parking assist method of a parking assist apparatus in accordance with a seventh embodiment of the present invention.

### DETAILED DESCRIPTIONS

Reference will now be made in detail to the embodiments of the present invention, examples of which are illustrated in the accompanying drawings, wherein like reference numerals refer to like elements throughout.

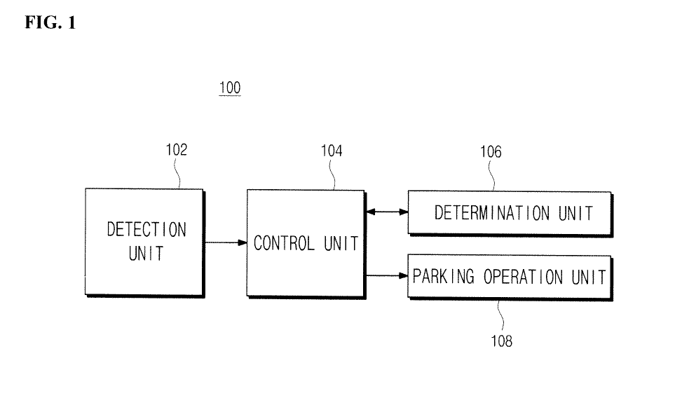

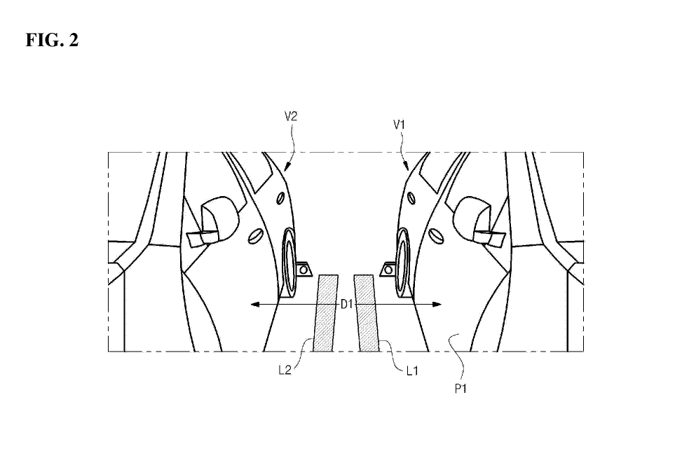

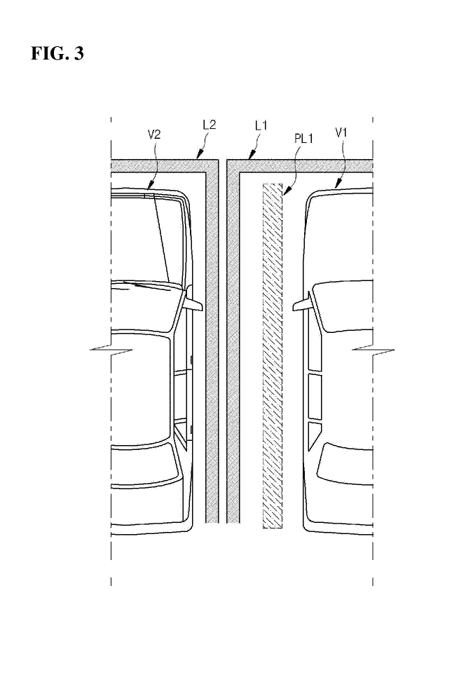

FIG. 1 is a block configuration view showing a parking assist apparatus in accordance with a first embodiment of the present invention, FIG. 2 is a partial perspective view showing an example of a process of detecting access information on door open with a current object in a detection unit shown in FIG. 1, and FIG. 3 is a partial plan view showing an example of a process of automatically parking a vehicle at a parking assist line corresponding to parking line information for enabling a door to be opened in a state in which parking assist line information for enabling a door to be opened is set in a control unit shown in FIG. 1.

Referring to FIGS. 1 to 3, a parking assist apparatus 100 in accordance with a first embodiment of the present invention includes a detection unit 102, a control unit 104, a determination unit 106, and a parking operation unit 108.

The detection unit 102 detects access information on door open with a current object V2 provided at a parking line L2 when parking a vehicle at a parking line L1.

As an example, the detection unit 102 may detect a door open access distance D1 with the current object V2 provided at the parking line L2 when parking the vehicle at the parking line L1.

Here, although not shown, the detection unit 102 may include at least one of an optical camera (not shown), an ultrasonic sensor (not shown), a radar sensor (not shown), an infrared sensor (not shown), and a blind spot area detection (BSD) sensor (not shown).

In this instance, although not shown, the current object V2 may be another vehicle, and may be at least one of an outer wall (not shown), a motorcycle (not shown), a bicycle (not shown), an animal (not shown), and another obstacle (not shown).

The control unit 104 receives access information on door open with the current object V2 detected in the detection unit 102, and includes a range of access information on door open with a reference object which is set in advance and parking assist line information for enabling a door of the vehicle to be opened.

The determination unit 106 determines whether access information on door open with the current object V2 detected in the detection unit 102 is in the range of access information on door open with the reference object in accordance with control of the control unit 104.

As an example, as shown in FIGS. 1 and 2, the determination unit 106 may determine whether the door open access distance D1 with the current object V2 corresponding to the access information on door open with the current object V2 is a door open access distance with the reference object corresponding to the access information on door open with the reference object in accordance with the control of the control unit 104.

In this instance, although not shown, the control unit 104 and the determination unit 106 may include a typical Electric Control Unit (ECU, not shown) for controlling and determining the overall operations using a main computer applied to a vehicle or a typical Micro Control Unit (MCU, not shown) for controlling and determining the overall operations using a processor, a memory, and an input/output device provided in a single chip, and may not be limited as long as they may control and determine the overall operations of the vehicle.

Here, the control unit 104 and the determination unit 106 may be constituted of an ECU or a MCU in an integrated manner, and an ECU or a MCU in a separated manner.

As shown in FIGS. 1 to 3, when it is determined in the determination unit 106 that the access information on door open with the current object V2 is in the range of access information on door open with the reference object, the parking operation unit 108 may automatically park a vehicle V2 at a parking assist line PL1 corresponding to parking line information S for enabling a door of the vehicle to be opened in accordance with the control of the control unit 104, so that door (P1) open with the current object V1 is possible.

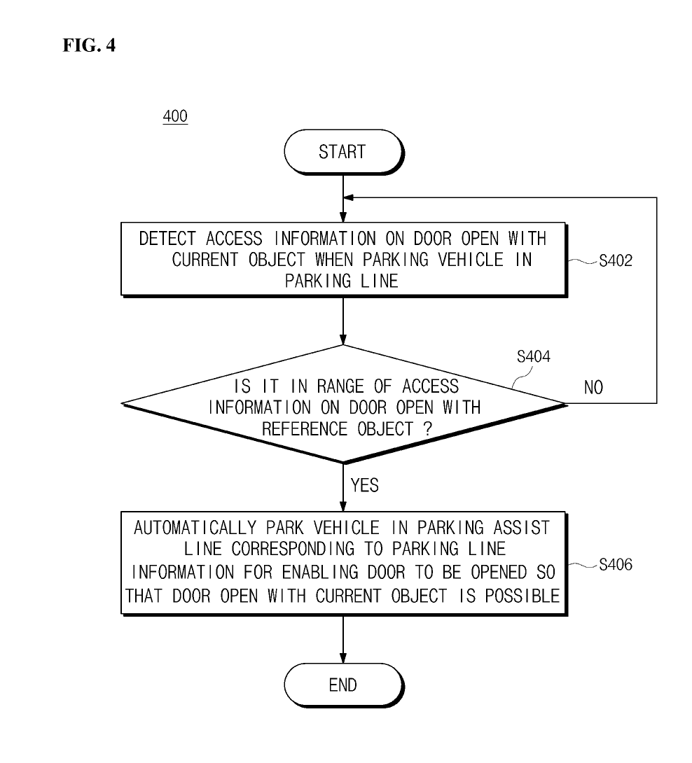

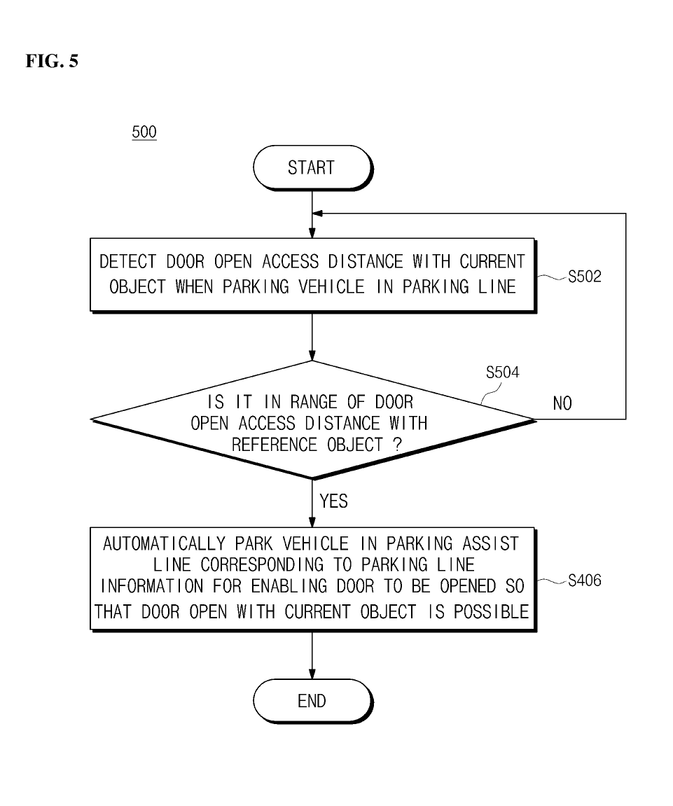

Hereinafter, a parking assist method for assisting parking using the parking assist apparatus 100 in accordance with the first embodiment of the present invention will be described with reference to FIGS. 4 and 5.

FIG. 4 is a flowchart showing a parking assist method of a parking assist apparatus in accordance with a first embodiment of the present invention, and FIG. 5 is a flowchart showing an example of a parking assist method of a parking assist apparatus in accordance with a first embodiment of the present invention.

Referring to FIGS. 4 and 5, the parking assist methods 400 and 500 of the parking assist apparatus (100 of FIG. 1) in accordance with the first embodiment of the present invention includes detecting operations S402 and S502, determining operations S404 and S504, and parking operation S406, respectively.

First, in detecting operation S402, the detection unit (102 of FIG. 1) detects access information on door open with a current object (V2 of FIG. 2) provided at a parking line (L2 of FIG. 2) when parking a vehicle at a parking line (L1 of FIG. 2).

As an example, as shown in FIG. 5, in detecting operation S502, the detection unit (102 of FIG. 1) may detect a door open access distance (D1 of FIG. 2) with the current object (V2 of FIG. 2) provided at the parking line (L2 of FIG. 2) when parking the vehicle at the parking line (L1 of FIG. 2).

Next, in determining operation S404, the determination unit (106 of FIG. 1) determines whether the access information on door open with the current object (V2 of FIG. 2) detected in the determination unit (102 of FIG. 1) is in a range of access information on door open with a reference object, which is set in the control unit (104 of FIG. 1), in accordance with control of the control unit (104 of FIG. 1).

As an example, as shown in FIG. 5, in determining operation S504, the determination unit (106 of FIG. 1) may determine whether the door open access distance (D1 of FIG. 2) with the current object (V2 of FIG. 2) corresponding to the access information on door open with the current object (V2 of FIG. 2) is in a range of a door open access distance with the reference object corresponding to the access information on door open with the reference object in accordance with the control of the control unit (104 of FIG. 1).

Finally, in parking operation S406, when it is determined in the determination unit (106 of FIG. 1) that the access information on door open with the current object (V2 of FIG. 2) is in the range of access information on door open with the reference object, the parking operation unit (108 of FIG. 1) automatically parks a vehicle (V1 of FIG. 3) at a parking assist line (PL1 of FIG. 3) corresponding to parking line information (S of FIG. 3) for enabling a door of the vehicle to be opened in accordance with the control of the control unit (104 of FIG. 1).

As described above, the parking assist apparatus 100 and the parking assist method 400 and 500 thereof in accordance with the first embodiment of the present invention include the detection unit 102, the control unit 104, the determination unit 106, and the parking operation unit 108, to perform detecting operations S402 and S502, determining operations S404 and S504, and parking operation S406.

Thus, in the parking assist apparatus 100 and the parking assist method 400 and 500 thereof in accordance with the first embodiment of the present invention, door open with the current object V2 may be possible, and therefore damage to a door unit of the vehicle V1 may be prevented in advance, thereby suppressing an increase in maintenance costs.

In addition, in the parking assist apparatus 100 and the parking assist method 400 and 500 thereof in accordance with the first embodiment of the present invention, door open with the current object V2 may be possible after parking the vehicle, thereby providing convenience to a passenger when the passenger gets out of the vehicle.

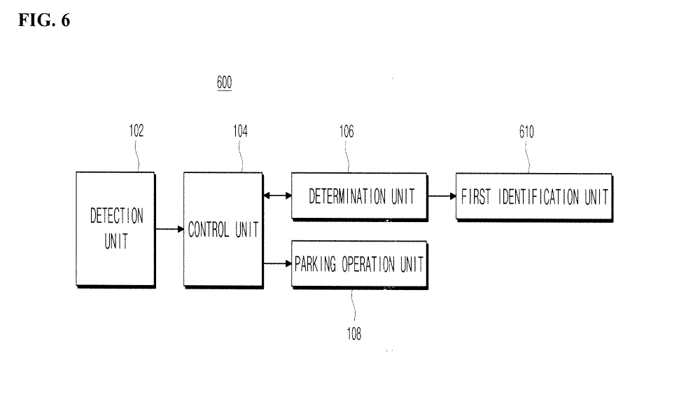

FIG. 6 is a block configuration view showing a parking assist apparatus in accordance with a second embodiment of the present invention.

Referring to FIG. 6, a parking assist apparatus 600 in accordance with a second embodiment of the present invention includes the detection unit 102, the control unit 104, the determination unit 106, and the parking operation unit 108 in the same manner as in the parking assist apparatus (100 of FIG. 1).

Functions of components included in the parking assist apparatus 600 in accordance with the second embodiment of the present invention and an organic connective relationship therebetween are the same as the functions of the components included in the parking assist apparatus (100 of FIG. 1) in accordance with the first embodiment of the present invention and the organic connective relationship therebetween, and thus additional description thereof will be omitted.

Here, the parking assist apparatus 600 in accordance with the second embodiment of the present invention may further include a first identification unit 610.

That is, when it is determined in the determination unit 106 that the access information on door open with the current object (V2 of FIG. 2) is in the range of access information on door open with the reference object, the first identification unit 610 identifies that the door (P1 of FIG. 2) cannot be currently opened.

In this instance, although not shown, the first identification unit 610 may include at least one of a speaker (not shown) and a light emitting member (not shown) which are provided to allow a driver to identify information or state of the vehicle and a Human Machine Interface (HMI) module (not shown) and a Head-UP Display (HUD) module (not shown) which are mounted to allow the driver to identify the information or state of the vehicle by interfacing a user with a machine, and identify that the door (P1 of FIG. 2) cannot be currently opened through at least one operation of a voice operation of the speaker (not shown), an emitting operation of the light emitting member (not shown), a HMI message display operation of the HMI module (not shown), and a HUD message display operation of the HUD module (not shown).

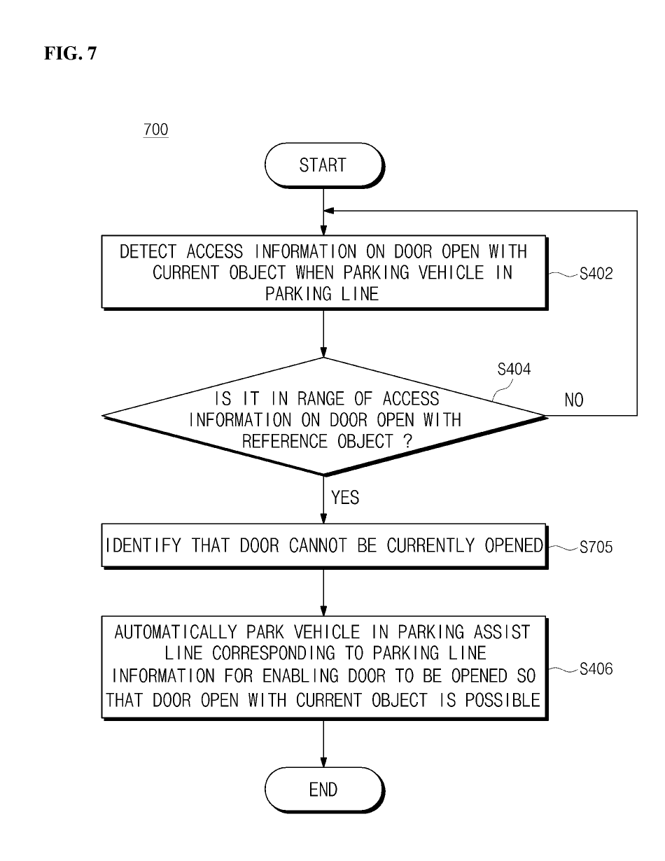

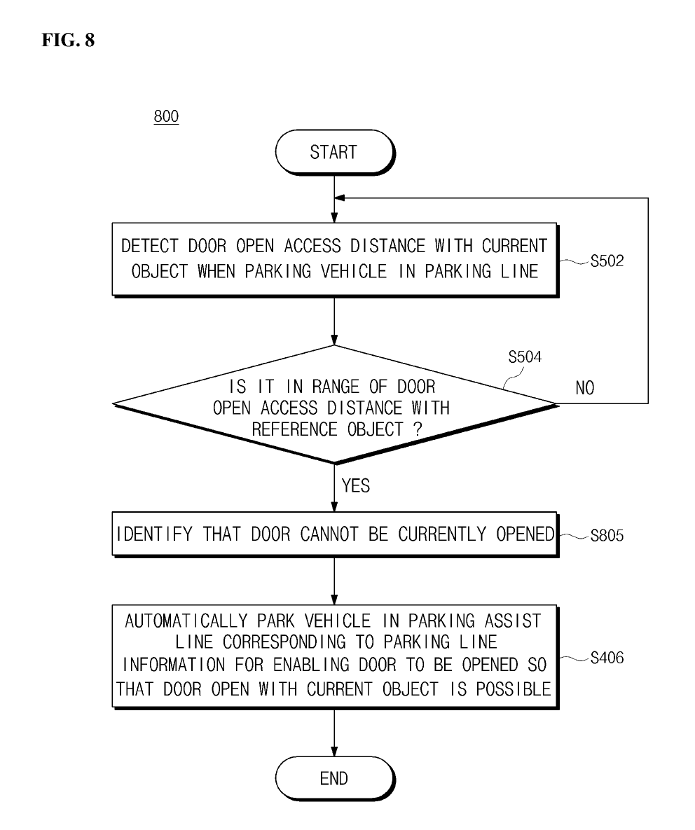

Hereinafter, the parking assist method for assisting parking using the parking assist apparatus 600 in accordance with the second embodiment of the present invention will be described with reference to FIGS. 7 and 8.

FIG. 7 is a flowchart showing a parking assist method of a parking assist apparatus in accordance with a second embodiment of the present invention, and FIG. 8 is a flowchart showing an example of a parking assist method of a parking assist apparatus in accordance with a second embodiment of the present invention.

Referring to FIGS. 7 and 8, the parking assist methods 700 and 800 of the parking assist apparatus (600 of FIG. 6) in accordance with the second embodiment of the present invention include detecting operations S402 and S502, determining operations S404 and S504, and parking operation S406, respectively, in the same manner as in the parking assist methods (400 and 500 of FIGS. 4 and 5) of the parking assist apparatus (100 of FIG. 1) in accordance with the first embodiment of the present invention.

Functions of operations included in the parking assist methods 700 and 800 of the parking assist apparatus (600 of FIG. 6) in accordance with the second embodiment of the present invention and an organic connective relationship therebetween are the same as the functions of operations included in the parking assist method (400 and 500 of FIGS. 4 and 5) of the parking assist apparatus (100 of FIG. 1) in accordance with the first embodiment of the present invention and the organic connective relationship therebetween, and thus additional description thereof will be omitted.

Here, the parking assist methods 700 and 800 of the parking assist apparatus (600 of FIG. 6) in accordance with the second embodiment of the present invention may further include first identifying operations S705 and S805 after determining operations S404 and S504, respectively.

As an example, the parking assist methods 700 and 800 of the parking assist apparatus (600 of FIG. 6) in accordance with the second embodiment of the present invention may further include first identifying operations S705 and S805 after determining operations S404 and S504 and before parking operation S406, respectively.

As another example, although not shown, the parking assist methods 700 and 800 of the parking assist apparatus (600 of FIG. 6) in accordance with the second embodiment of the present may be further performed with the parking operation (not shown) synchronized with the first identifying operation (not shown).

That is, when it is determined that the access information on door open with the current object (V2 of FIG. 2) is in the range of access information on door open with the reference object, first identifying operations S705 and S805 identify that the door (P1 of FIG. 2) cannot be currently opened.

As described above, the parking assist apparatus 600 and the parking assist methods 700 and 800 thereof in accordance with the second embodiment of the present invention may include the detection unit 102, the control unit 104, the determination unit 106, the first identification unit 610, and the parking operation unit 108, to perform detecting operations S402 and S502, determining operations S404 and S504, first identifying operations S705 and S805, and parking operation S406.

Thus, in the parking assist apparatus 600 and the parking assist methods 700 and 800 thereof in accordance with the second embodiment of the present invention, door open with the current object V2 is possible after parking the vehicle, and therefore the damage to the door unit of the vehicle V1 may be prevented in advance, thereby suppressing an increase in maintenance costs.

In addition, in the parking assist apparatus 600 and the parking assist methods 700 and 800 thereof in accordance with the second embodiment of the present invention, door open with the current object V2 is possible after parking the vehicle, thereby providing convenience to a passenger when the passenger gets out of the vehicle.

In addition, in the parking assist apparatus 600 and the parking assist methods 700 and 800 thereof in accordance with the second embodiment of the present invention, it may be identified that the door P1 cannot be currently opened, when the access information on door open with the current object V2 is in the range of access information on door open with the reference object.

Thus, in the parking assist apparatus 600 and the parking assist methods 700 and 800 thereof in accordance with the second embodiment of the present invention, the damage to the door unit of the vehicle V1 may be prevented in advance, thereby further suppressing the increase in maintenance costs.

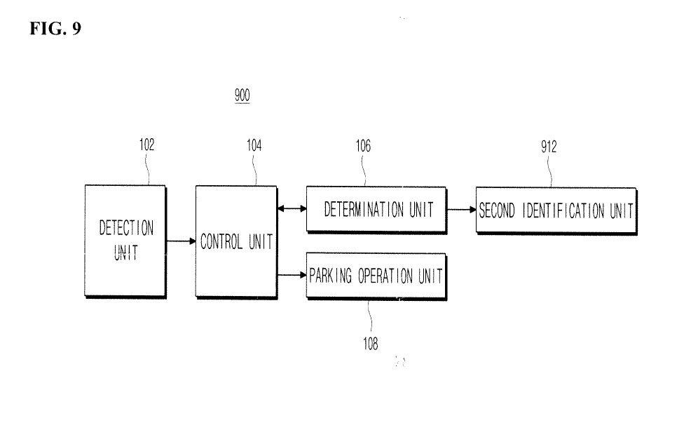

FIG. 9 is a block configuration view showing a parking assist apparatus in accordance with a third embodiment of the present invention.

Referring to FIG. 9, a parking assist apparatus 900 in accordance with a third embodiment of the present invention includes the detection unit 102, the control unit 104, the determination unit 106, and the parking operation unit 108 in the same manner as in the parking assist apparatus (100 of FIG. 1) in accordance with the first embodiment of the present invention.

Functions of components included in the parking assist apparatus 900 in accordance with the third embodiment of the present invention and an organic connective relationship therebetween are the same as the functions of components included in the parking assist apparatus (100 of FIG. 1) in accordance with the first embodiment of the present invention and the organic connective relationship therebetween, and thus additional description thereof will be omitted.

Here, the parking assist apparatus 900 in accordance with the third embodiment of the present invention may further include a second identification unit 912.

That is, when it is determined in the determination unit 106 that the access information on door open with the current object (V2 of FIG. 2) is in the range of access information on door open with the reference object, the second identification unit 912 identifies that the vehicle (V1 of FIG. 3) is automatically parked at the parking assist line (PL1 of FIG. 3) corresponding to the parking line information (S of FIG. 3) for enabling the door to be opened.

In this instance, although not shown, the second identification unit 912 may include at least one of a speaker (not shown) and a light emitting member (not shown) which are provided to allow a driver to identify information or state of the vehicle and a HMI module (not shown) and a HUD module (not shown) which are mounted to allow the driver to identify the information or state of the vehicle by interfacing a user with a machine, and identify that the vehicle (V1 of FIG. 3) may be automatically parked at the parking assist line (PL1 of FIG. 3) corresponding to the parking line information (S of FIG. 3) for enabling the door to be opened, through at least one operation of a voice operation of the speaker (not shown), an emitting operation of the light emitting member (not shown), a HMI message display operation of the HMI module (not shown), and a HUD message display operation of the HUD module (not shown).

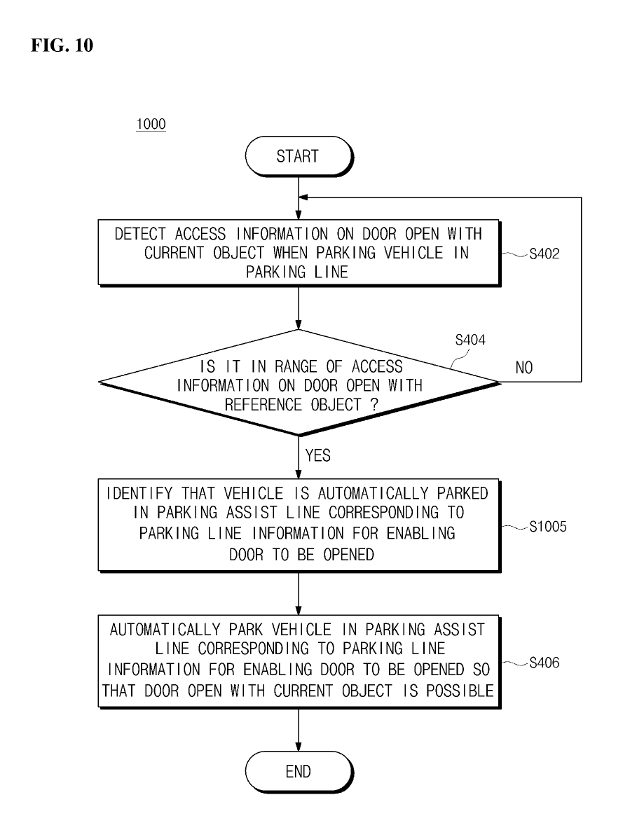

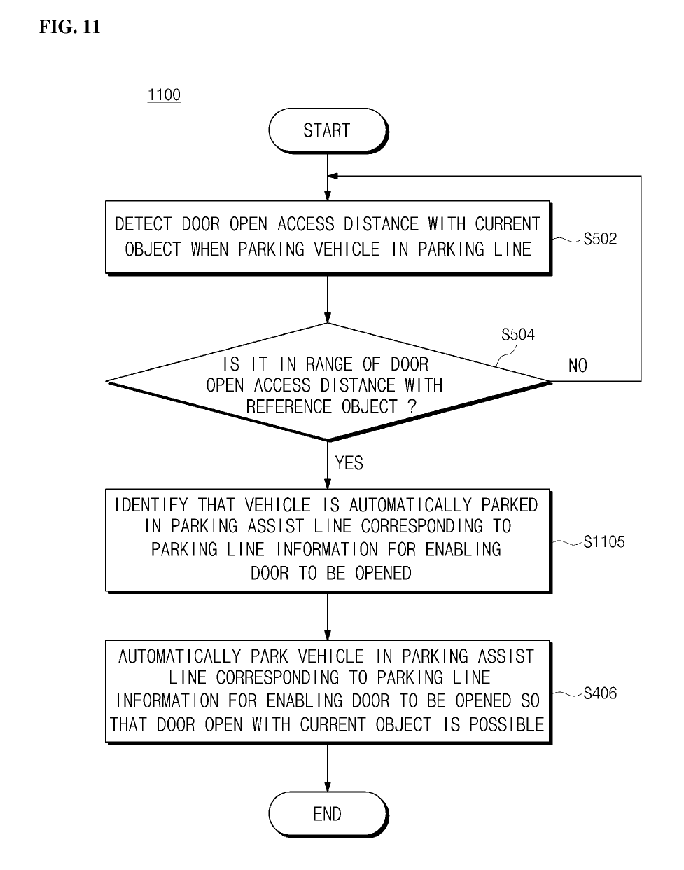

Hereinafter, the parking assist method for assisting parking using the parking assist apparatus 900 in accordance with the third embodiment of the present invention will be described with reference to FIGS. 10 and 11.

FIG. 10 is a flowchart showing a parking assist method of a parking assist apparatus in accordance with a third embodiment of the present invention, and FIG. 11 is a flowchart showing an example of a parking assist method of a parking assist apparatus in accordance with a third embodiment of the present invention.

Referring to FIGS. 10 and 11, the parking assist methods 1000 and 1100 of the parking assist apparatus (900 of FIG. 9) in accordance with the third embodiment of the present invention includes detecting operations S402 and S502, determining operations S404 and S504, first identifying operations S705 and S805, and parking operation S406, respectively, in the same manner as in the parking assist methods (400 and 500 of FIGS. 4 and 5) of the parking assist apparatus (100 of FIG. 1) in accordance with the first embodiment of the present invention.

Functions of operations included in the parking assist methods 1000 and 1100 of the parking assist apparatus (900 of FIG. 9) in accordance with the third embodiment of the present invention and an organic connective relationship therebetween are the same as the functions of operations included in the parking assist methods (400 and 500 of FIGS. 4 and 5) of the parking assist apparatus (100 of FIG. 1) in accordance with the first embodiment of the present invention and the organic connective relationship therebetween, and thus additional description thereof will be omitted.

Here, the parking assist method 1000 and 1100 of the parking assist apparatus (900 of FIG. 9) in accordance with the third embodiment of the present invention may further include second identifying operations S1005 and S1105 after determining operations S404 and S504, respectively.

As an example, the parking assist methods 1000 and 1100 of the parking assist apparatus (900 of FIG. 9) in accordance with the third embodiment of the present invention may further include second identifying operations S1005 and S1105 after determining operations S404 and S504 and before parking operation S406, respectively.

As another example, although not shown, the parking assist methods 1000 and 1100 of the parking assist apparatus (900 of FIG. 9) in accordance with the third embodiment of the present invention may be further performed with the parking operation (not shown) synchronized with the second identifying operation (not shown).

That is, when it is determined in the determination unit (106 of FIG. 9) that the access information on door open with the current object (V2 of FIG. 2) is in the range of access information on door open with the reference object, in the second identifying operations S1005 and S1105, the second identification unit (912 of FIG. 9) identifies that the vehicle (V1 of FIG. 3) is automatically parked at the parking assist line (PL1 of FIG. 3) corresponding to the parking line information (S of FIG. 3) for enabling the door to be opened.

The parking assist apparatus 900 and the parking assist methods 1000 and 1100 in accordance with the third embodiment of the present invention may include the detection unit 102, the control unit 104, the determination unit 106, the second identification unit 912, and the parking operation unit 108, to perform detecting operations S402 and S502, determining operations S404 and S504, second identifying operations S1005 and S1105, and parking operation S406, respectively.

Thus, in the parking assist apparatus 900 and the parking assist methods 1000 and 1100 in accordance with the third embodiment of the present invention, door open with the current object V2 may be possible after parking the vehicle, and therefore damage to the door unit of the vehicle V1 may be prevented in advance, thereby suppressing an increase in maintenance costs.

In addition, in the parking assist apparatus 900 and the parking assist methods 1000 and 1100 in accordance with the third embodiment of the present invention, door open with the current object V2 may be possible after parking the vehicle, thereby providing convenience to a passenger when the passenger gets out of the vehicle.

In addition, when the access information on door open with the current object V2 is in the range of access information on door open with the reference object, the parking assist apparatus 900 and the parking assist methods 1000 and 1100 in accordance with the third embodiment of the present invention may identify that the vehicle may be automatically parked at the parking assist line PL1 corresponding to the parking line information S for enabling the door to be opened.

Accordingly, in the parking assist apparatus 900 and the parking assist methods 1000 and 1100 in accordance with the third embodiment of the present invention, the passenger may recognize that the vehicle V1 can be automatically parked at the parking assist line PL1 corresponding to the parking line information S for enabling the door to be opened.

Thus, the parking assist apparatus 900 and the parking assist methods 1000 and 1100 in accordance with the third embodiment of the present invention may reduce the excessive operation frequency of the door unit, and therefore the damage to the door unit of the vehicle V1 may be prevented in advance, thereby further suppressing the increase in the maintenance costs.

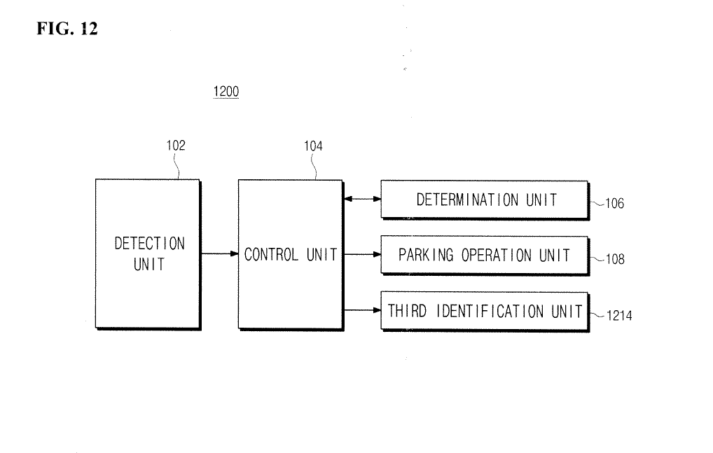

FIG. 12 is a block configuration view showing a parking assist apparatus in accordance with a fourth embodiment of the present invention.

Referring to FIG. 12, a parking assist apparatus 1200 in accordance with a fourth embodiment of the present invention includes the detection unit 102, the control unit 104, the determination unit 106, and the parking operation unit 108 in the same manner as in the parking assist apparatus (100 of FIG. 1) in accordance with the first embodiment of the present invention.

Functions of components included in the parking assist apparatus 1200 in accordance with the fourth embodiment of the present invention and an organic connective relationship therebetween are the same as the functions of components included in the parking assist apparatus (100 of FIG. 1) in accordance with the first embodiment of the present invention and the organic connective relationship therebetween, and thus additional description thereof will be omitted.

Here, the parking assist apparatus 1200 in accordance with the fourth embodiment of the present invention may further include a third identification unit 1214.

That is, the third identification unit 1214 may identify that the door can be currently opened when parking of the vehicle (V1 of FIG. 3) at the parking assist line (PL1 of FIG. 3) corresponding to the parking line information (S of FIG. 3) for enabling the door to be opened is automatically completed in accordance with control of the control unit 104 in the parking operation unit 108.

In this instance, although not shown, the third identification unit 1214 may include at least one of a speaker (not shown) and a light emitting member (not shown) which are provided to allow a driver to identify information or state of the vehicle and a HMI module (not shown) and a HUD module (not shown) which are mounted to allow the driver to identify the information or state of the vehicle by interfacing a user with a machine, and identify that the door may be currently opened through at least one operation of a voice operation of the speaker (not shown), an emitting operation of the light emitting member (not shown), a HMI message display operation of the HMI module (not shown), and a HUD message display operation of the HUD module (not shown).

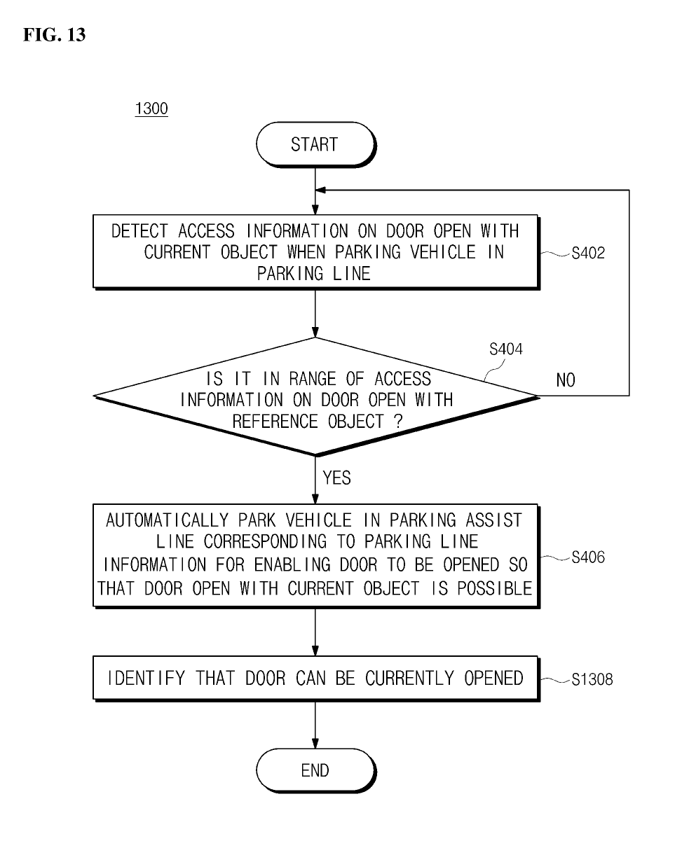

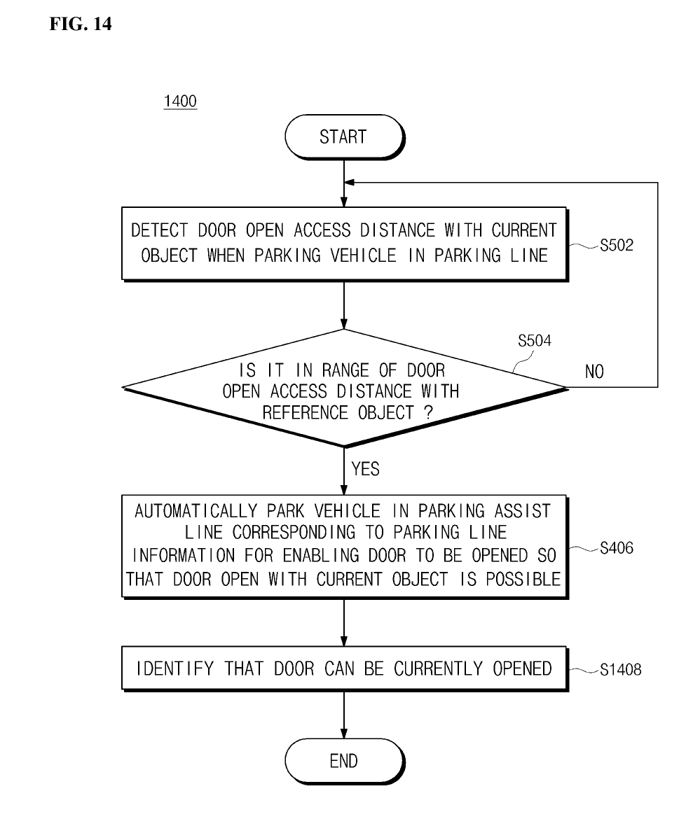

A parking assist method for assisting parking using the parking assist apparatus 1200 in accordance with the fourth embodiment of the present invention will be described with reference to FIGS. 13 and 14.

FIG. 13 is a flowchart showing a parking assist method of a parking assist apparatus in accordance with a fourth embodiment of the present invention, and FIG. 14 is a flowchart showing an example of a parking assist method of a parking assist apparatus in accordance with a fourth embodiment of the present invention.

Referring to FIGS. 13 and 14, the parking assist methods 1300 and 1400 of the parking assist apparatus (1200 of FIG. 12) in accordance with the fourth embodiment of the present invention includes detecting operations S402 and S502, determining operations S404 and S504, second identifying operations S1005 and S1105, and parking operation S406 in the same manner as in the parking assist methods (400 and 500 of FIGS. 4 and 5) of the parking assist apparatus (100 of FIG. 1) in accordance with the first embodiment of the present invention, respectively.

Functions of operations included in the parking assist methods 1300 and 1400 of the parking assist apparatus (1200 of FIG. 12) in accordance with the fourth embodiment of the present invention and an organic connective relationship therebetween are the same as the functions of operations included in the parking assist methods (400 and 500 of FIGS. 4 and 5) of the parking assist apparatus (100 of FIG. 1) in accordance with the first embodiment of the present invention and the organic connective relationship therebetween, and thus additional description thereof will be omitted.

Here, the parking assist methods 1300 and 1400 of the parking assist apparatus (1200 of FIG. 12) in accordance with the fourth embodiment of the present invention may further include third identifying operations S1308 and S1408 after parking operation S406, respectively.

That is, in the third identifying operations S1308 and S1408, when parking of the vehicle (V1 of FIG. 3) at the parking assist line (PL1 of FIG. 3) corresponding to the parking line information (S of FIG. 12) is automatically completed in the control of the control unit (104 of FIG. 12) by the parking operation unit (108 of FIG. 12), the third identification unit (1214 of FIG. 12) identifies that the door may be currently opened.

In this manner, the parking assist methods 1300 and 1400 of the parking assist apparatus (1200 of FIG. 12) in accordance with the fourth embodiment of the present invention includes the detection unit 102, the control unit 104, the determination unit 106, the parking operation unit 108, and the third identification unit 1214, to perform detecting operations S402 and S502, determining operations S404 and S504, parking operation S406, and third identifying operations S1308 and S1408, respectively.

Thus, in the parking assist methods 1300 and 1400 of the parking assist apparatus (1200 of FIG. 12) in accordance with the fourth embodiment of the present invention, door open with the current object V2 is possible, and therefore damage to the door unit of the vehicle V1 may be prevented in advance, thereby suppressing an increase in maintenance costs.

In addition, in the parking assist methods 1300 and 1400 of the parking assist apparatus (1200 of FIG. 12) in accordance with the fourth embodiment of the present invention, door open with the current object V2 is possible after parking the vehicle, thereby providing convenience to a passenger when the passenger gets out the vehicle.

In addition, in the parking assist methods 1300 and 1400 of the parking assist apparatus (1200 of FIG. 12) in accordance with the fourth embodiment of the present invention, when parking of the vehicle V1 at the parking assist line PL1 corresponding to the parking line information S for enabling the door to be opened is automatically completed, it may be identified that the door can be currently opened.

Accordingly, in the parking assist methods 1300 and 1400 of the parking assist apparatus (1200 of FIG. 12) in accordance with the fourth embodiment of the present invention, the passenger may recognize that parking of the vehicle V1 at the parking assist line PL1 corresponding to the parking line information S for enabling the door to be opened is automatically completed and the door may be currently opened.

Thus, the parking assist methods 1300 and 1400 of the parking assist apparatus (1200 of FIG. 12) in accordance with the fourth embodiment of the present invention may reduce the excessive operation frequency of the door unit, and therefore the damage to the door unit of the vehicle V1 may be prevented in advance, thereby further suppressing the increase in the maintenance costs.

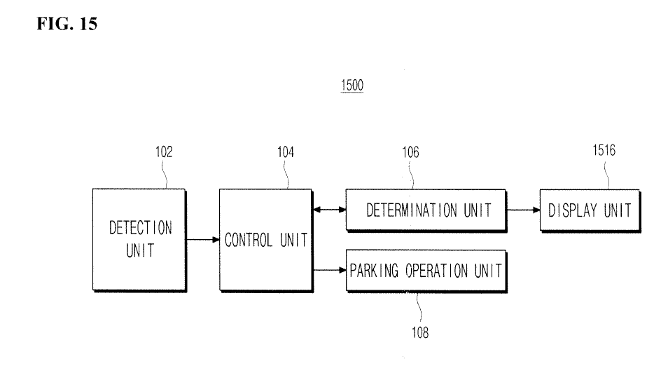

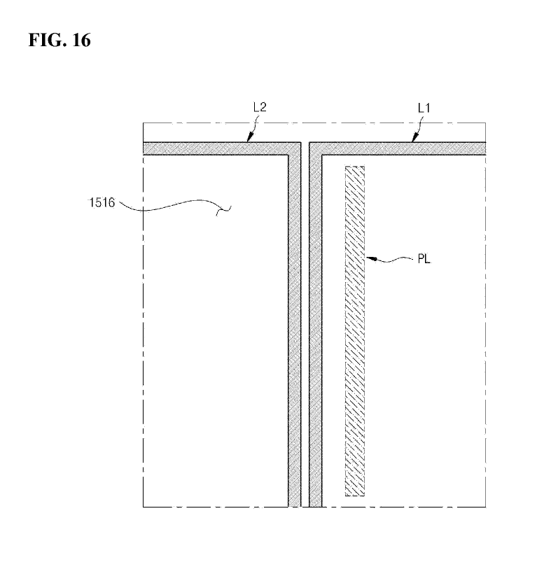

FIG. 15 is a block configuration view showing a parking assist apparatus in accordance with a fifth embodiment of the present invention, and FIG. 16 is a partial plan view showing an example of a process of displaying parking line information for enabling a door to be opened on a screen in a display unit shown in FIG. 15.

Referring to FIG. 15, a parking assist apparatus 1500 in accordance with a fifth embodiment of the present invention includes the detection unit 102, the control unit 104, and the determination unit 106 in the same manner as in the parking assist apparatus (100 of FIG. 1) in accordance with the first embodiment of the present invention.

Functions of components included in the parking assist apparatus 1500 in accordance with the fifth embodiment of the present invention and an organic connective relationship therebetween are the same as the functions of components included in the parking assist apparatus (100 of FIG. 1) in accordance with the first embodiment of the present invention and the organic connective relationship therebetween, and thus additional description thereof will be omitted.

Here, the parking assist apparatus 1500 in accordance with the fifth embodiment of the present invention may further include a display unit 1516 and the parking operation unit 108.

As shown in FIGS. 15 and 16, when it is determined in the determination unit 106 that the access information on door open with the current object (V2 of FIG. 2) is in the range of access information on door open with the reference object, the display unit 1516 displays, on a screen, the parking line information S for enabling the door to be opened in accordance with the control of the control unit 104 so that door (P1 of FIG. 2) open with the current object (V2 of FIG. 2) is possible. In this instance, although not shown, the display unit 1516 may be a parking camera (not shown) used to determine a parking state at the time of parking.

The parking operation unit 108 determines the parking line information S for enabling the door to be opened, which is displayed in the display unit 1516, to thereby park the vehicle (V1 of FIG. 2) close to the parking assist line PL1 corresponding to the parking line information S for enabling the door to be opened, based on an intention of a driver in accordance with the control of the control unit 104.

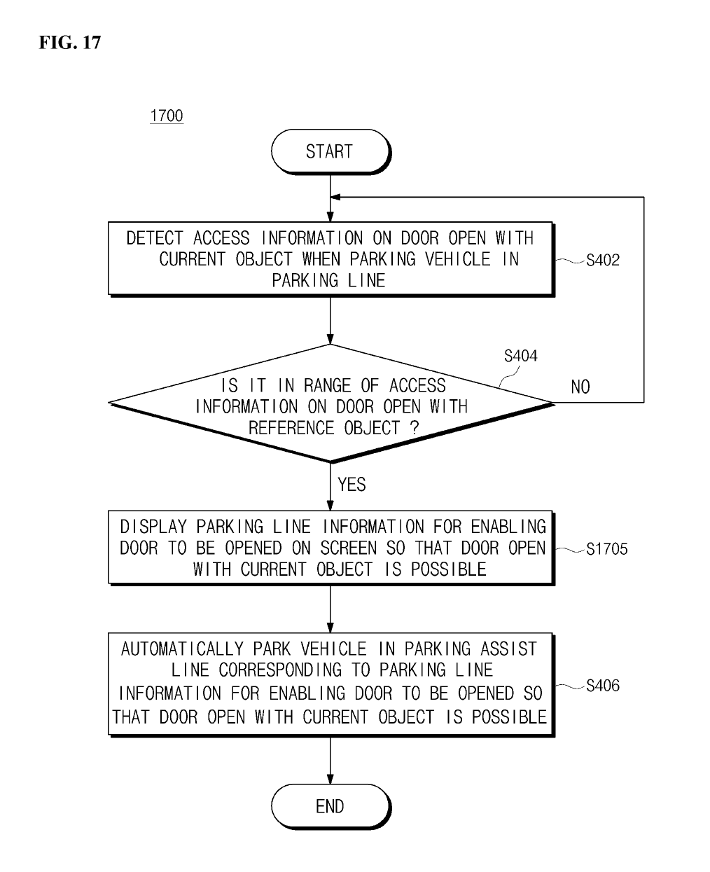

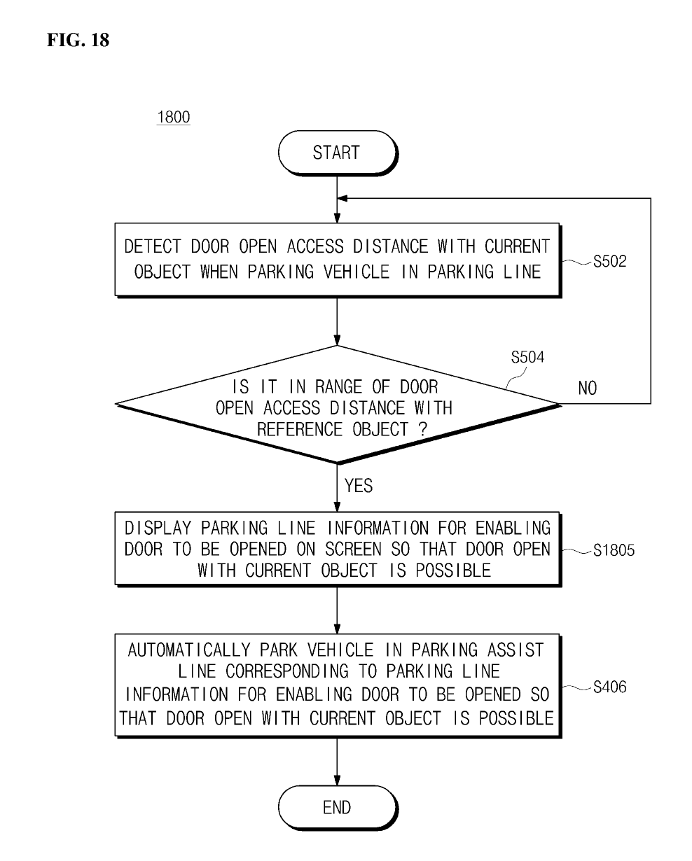

Hereinafter, a parking assist method for assisting parking using the parking assist apparatus 1500 in accordance with the fifth embodiment of the present invention will be described in detail with reference to FIGS. 17 and 18.

FIG. 17 is a flowchart showing a parking assist method of a parking assist apparatus in accordance with a fifth embodiment of the present invention, and FIG. 18 is a flowchart showing an example of a parking assist method of a parking assist apparatus in accordance with a fifth embodiment of the present invention.

Referring to FIGS. 17 and 18, the parking assist methods 1700 and 1800 of the parking assist apparatus (1500 of FIG. 15) in accordance with the fifth embodiment of the present invention respectively includes detecting operations S402 and S502 and determining operations S404 and S504 in the same manner as in the parking assist methods (400 and 500 of FIGS. 4 and 5) of the parking assist apparatus (100 of FIG. 1) in accordance with the first embodiment of the present invention.

Functions of operations included in the parking assist methods 1700 and 1800 of the parking assist apparatus (1500 of FIG. 15) in accordance with the fourth embodiment of the present invention and an organic connective relationship therebetween are the same as the functions of operations included in the parking assist methods (400 and 500 of FIGS. 4 and 5) of the parking assist apparatus (100 of FIG. 1) in accordance with the first embodiment of the present invention and the organic connective relationship therebetween, and thus additional description thereof will be omitted.

Here, the parking assist methods 1700 and 1800 of the parking assist apparatus (1500 of FIG. 15) in accordance with the fifth embodiment of the present invention may further include displaying operations S1705 and S1805 and parking operation S406 after determining operations S404 and S504, respectively.

That is, in displaying operations in S1705 and S1805, when it is determined in the determination unit (106 of FIG. 15) that the access information on door open with the current object (V2 of FIG. 2) is in the range of access information on door open with the reference object, the display unit (1516 of FIG. 15) displays, on a screen, the parking line information (S of FIG. 16) for enabling the door to be opened in accordance with the control of the control unit (104 of FIG. 15) so that door (P1 of FIG. 2) open with the current object (V2 of FIG. 2) is possible.

Finally, in parking operation S406, the parking operation unit (108 of FIG. 15) determines the parking line information (S of FIG. 16) for enabling the door to be opened, which is displayed in the display unit (1516 of FIG. 15), to thereby park the vehicle (V1 of FIG. 2) close to the parking assist line (PL1 of FIG. 16) corresponding to the parking line information (S of FIG. 16) for enabling the door to be opened based on the intention of the driver in accordance with the control of the control unit (104 of FIG. 15).

In this manner, the parking assist methods 1700 and 1800 of the parking assist apparatus 1500 in accordance with the fifth embodiment of the present invention includes the detection unit 102, the control unit 104, the determination unit 106, the display unit 1516, and the parking operation unit 108 to perform, detecting operations S402 and S502, determining operations S404 and S504, displaying operations S1705 and S1805, and parking operation S406, respectively.

Accordingly, in the parking assist methods 1700 and 1800 of the parking assist apparatus 1500 in accordance with the fifth embodiment of the present invention, door open with the current object V2 is possible after parking the vehicle, and therefore damage to the door unit of the vehicle V1 may be prevented in advance, thereby suppressing an increase in maintenance costs.

In addition, in the parking assist methods 1700 and 1800 of the parking assist apparatus 1500 in accordance with the fifth embodiment of the present invention, door open with the current object V2 is possible after parking the vehicle, thereby providing convenience to a passenger when the passenger gets out of the vehicle.

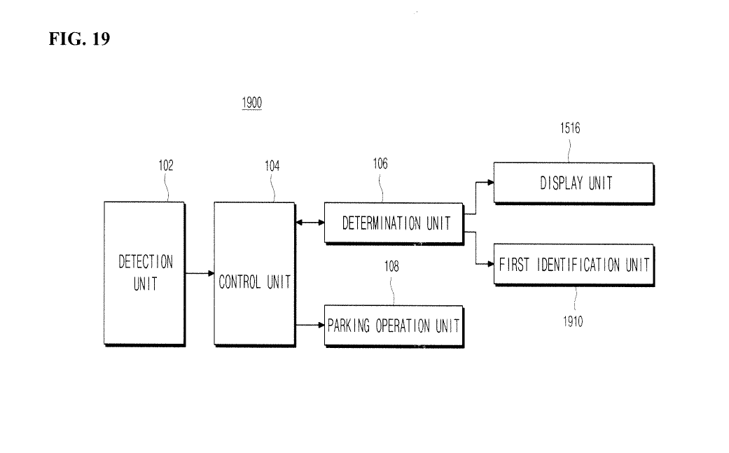

FIG. 19 is a block configuration view showing a parking assist apparatus in accordance with a sixth embodiment of the present invention.

Referring to FIG. 19, a parking assist apparatus 1900 in accordance with a sixth embodiment of the present invention includes the detection unit 102, the control unit 104, the determination unit 106, the display unit 1516, and the parking operation unit 108 in the same manner as in the parking assist apparatus (1500 of FIG. 15) in accordance with the fifth embodiment of the present invention.

Functions of components included in the parking assist apparatus 1900 in accordance with the sixth embodiment of the present invention and an organic connective relationship therebetween are the same as the functions of components included in the parking assist apparatus (1500 of FIG. 15) in accordance with the fifth embodiment of the present invention and the organic connective relationship therebetween, and thus additional description thereof will be omitted.

Here, the parking assist apparatus 1900 in accordance with the sixth embodiment of the present invention further includes a first identification unit 1910.

That is, when it is determined in the determination unit 106 that the access information on door open with the current object (V2 of FIG. 2) is in the range of access information on door open with the reference object, the first identification unit 1910 identifies that the door (P1 of FIG. 2) cannot be currently opened.

In this instance, although not shown, the first identification unit 1910 may include at least one of a speaker (not shown) and a light emitting member (not shown) which are provided to allow a driver to identify information or state of the vehicle and a HMI module (not shown) and a HUD module (not shown) which are mounted to allow the driver to identify the information or state of the vehicle by interfacing a user with a machine, and identify that the door (P1 of FIG. 2) cannot be currently opened, through at least one operation of a voice operation of the speaker (not shown), an emitting operation of the light emitting member (not shown), a HMI message display operation of the HMI module (not shown), and a HUD message display operation of the HUD module (not shown).

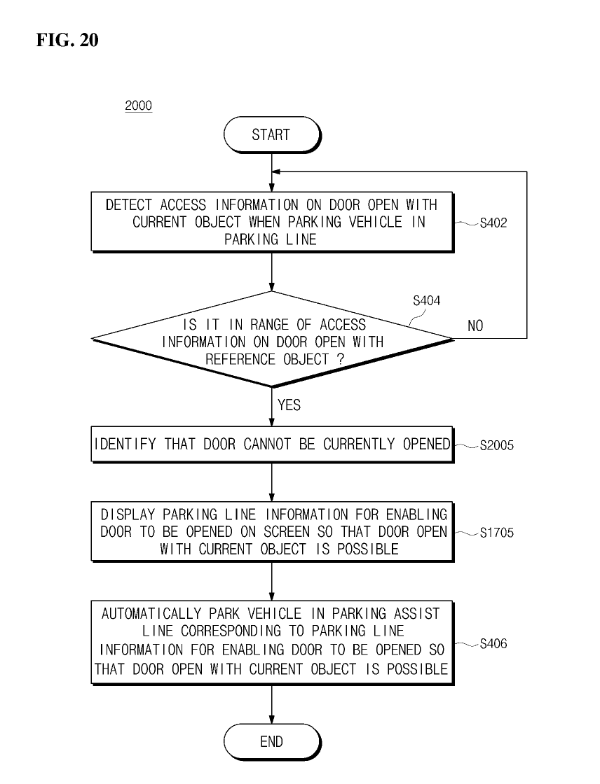

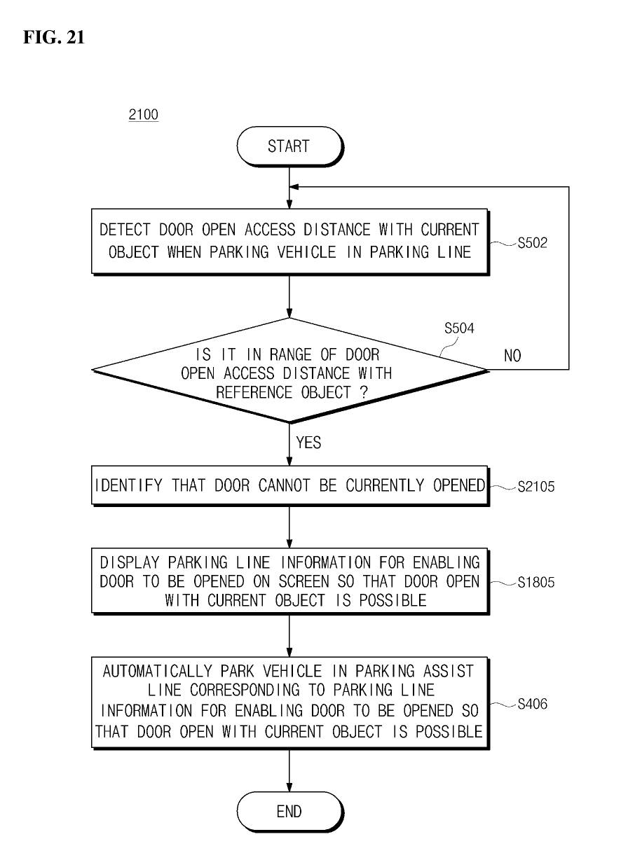

Hereinafter, a parking assist method for assisting parking using the parking assist apparatus 1900 in accordance with the sixth embodiment of the present invention will be described with reference to FIGS. 20 and 21.

FIG. 20 is a flowchart showing a parking assist method of a parking assist apparatus in accordance with a sixth embodiment of the present invention, and FIG. 21 is a flowchart showing an example of a parking assist method of a parking assist apparatus in accordance with a sixth embodiment of the present invention.

Referring to FIGS. 20 and 21, the parking assist methods 2000 and 2100 of the parking assist apparatus (1900 of FIG. 19) in accordance with the sixth embodiment of the present invention respectively includes detecting operations S402 and S502, determining operations S404 and S504, displaying operations S1705 and S1805, and parking operation S406 in the same manner as in the parking assist methods 1700 and 1800 of the parking assist apparatus (1500 of FIG. 15) in accordance with the fifth embodiment of the present invention.

Functions of operations included in the parking assist methods 2000 and 2100 of the parking assist apparatus (1900 of FIG. 19) in accordance with the sixth embodiment of the present invention and an organic connective relationship therebetween are the same as the functions of operations included in the parking assist methods (400 and 500 of FIGS. 4 and 5) of the parking assist apparatus (1500 of FIG. 15) in accordance with the fifth embodiment of the present invention and the organic connective relationship therebetween, and thus additional description thereof will be omitted.

Here, the parking assist methods 2000 and 2100 of the parking assist apparatus (1900 of FIG. 19) in accordance with the sixth embodiment of the present invention may further include first identifying operations S2005 and S2015 after determining operations S404 and S504, respectively.

As an example, the parking assist methods 2000 and 2100 of the parking assist apparatus (1900 of FIG. 19) in accordance with the sixth embodiment of the present invention may further include first identifying operations S2005 and S2015 after determining operations S404 and S504 and before displaying operations S1705 and S1805, respectively.

As another example, although not shown, the parking assist methods 2000 and 2100 of the parking assist apparatus (1900 of FIG. 19) in accordance with the sixth embodiment of the present invention may be further performed with the displaying operation (not shown) synchronized with the first identifying operation (not shown).

That is, in the first identifying operations S2005 and S2015, when it is determined in the determination unit (106 of FIG. 16) that the access information on door open with the current object (V2 of FIG. 2) is in the range of access information on door open with the reference object, the first identification unit (1910 of FIG. 19) identifies that the door (P1 of FIG. 2) cannot be currently opened.

The parking assist methods 2000 and 2100 of the parking assist apparatus 1900 in accordance with the sixth embodiment of the present invention includes the detection unit 102, the control unit 104, the determination unit 106, the first identification unit 1910, the display unit 1516, and the parking operation unit 108 to perform, detecting operations S402 and S502, determining operations S404 and S504, first identifying operations S2005 and S2015, displaying operations S1705 and S1805, and parking operation S406, respectively.

Thus, in the parking assist methods 2000 and 2100 of the parking assist apparatus 1900 in accordance with the sixth embodiment of the present invention, door open with the current object V2 is possible after parking the vehicle, and therefore damage to the door unit of the vehicle V1 may be prevented in advance, thereby suppressing an increase in maintenance costs.

In addition, in the parking assist methods 2000 and 2100 of the parking assist apparatus 1900 in accordance with the sixth embodiment of the present invention, door open with the current object V2 is possible after parking the vehicle, thereby providing convenience to a passenger when the passenger gets out of the vehicle.

In addition, in the parking assist methods 2000 and 2100 of the parking assist apparatus 1900 in accordance with the sixth embodiment of the present invention, when the access information on door open with the current object V2 is in the range of the access information on door open with the reference object, it may be identified that the current P1 cannot be currently opened.

Accordingly, in the parking assist methods 2000 and 2100 of the parking assist apparatus 1900 in accordance with the sixth embodiment of the present invention, the passenger may recognize that the door P1 cannot be currently opened.

Thus, the parking assist apparatus 1900 and the parking assist methods 2000 and 2100 in accordance with the sixth embodiment of the present invention may reduce the excessive operation frequency of the door unit, and therefore the damage to the door unit of the vehicle V1 may be prevented in advance, thereby further suppressing the increase in the maintenance costs.

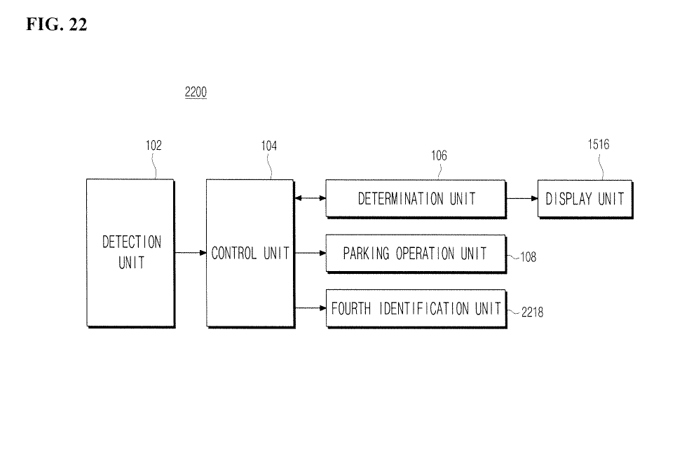

FIG. 22 is a block configuration view showing a parking assist apparatus in accordance with a seventh embodiment of the present invention.

Referring to FIG. 22, a parking assist apparatus 2200 in accordance with a seventh embodiment of the present invention includes the detection unit 102, the control unit 104, the determination unit 106, the display unit 1516, and the parking operation unit 108 in the same manner as in the parking assist apparatus (1500 of FIG. 15) in accordance with the fifth embodiment of the present invention.

Functions of components included in the parking assist apparatus 2200 in accordance with the seventh embodiment of the present invention and an organic connective relationship therebetween are the same as the functions of components included in the parking assist apparatus (1500 of FIG. 15) in accordance with the fifth embodiment of the present invention and the organic connective relationship therebetween, and thus additional description thereof will be omitted.

Here, the parking assist apparatus 2200 in accordance with the seventh embodiment of the present invention may further include a fourth identification unit 2218.

That is, when parking of the vehicle (V1 of FIG. 2) close to the parking assist line (PL1 of FIG. 16) corresponding to the parking line information (S of FIG. 16) for enabling the door to be opened is completed, based on the intention of the driver, in accordance with the control of the control unit 104 by the parking operation unit 108, the fourth identification unit 2218 identifies that the door may be currently opened.

In this instance, although not shown, the fourth identification unit 2218 may include at least one of a speaker (not shown) and a light emitting member (not shown) which are provided to allow a driver to identify information or state of the vehicle and a HMI module (not shown) and a HUD module (not shown) which are mounted to allow the driver to identify the information or state of the vehicle by interfacing a user with a machine, and identify that the door can be currently opened, through at least one operation of a voice operation of the speaker (not shown), an emitting operation of the light emitting member (not shown), a HMI message display operation of the HMI module (not shown), and a HUD message display operation of the HUD module (not shown).

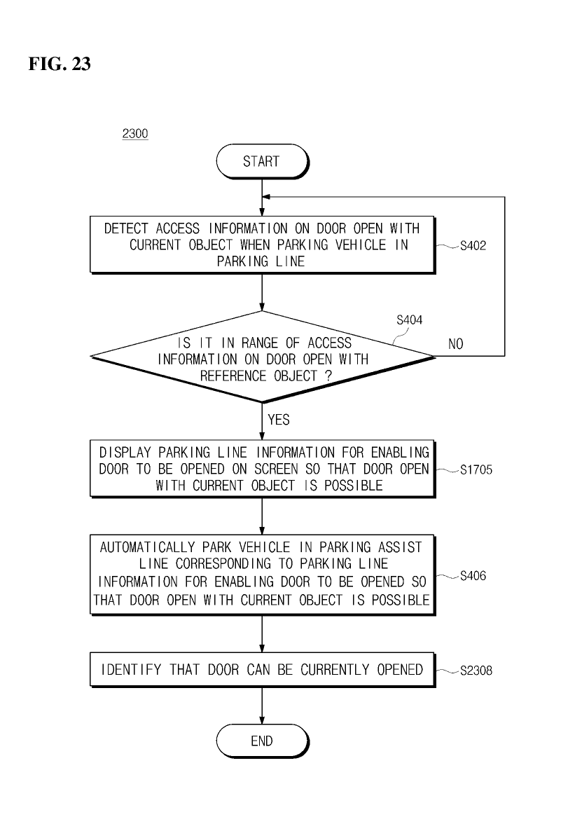

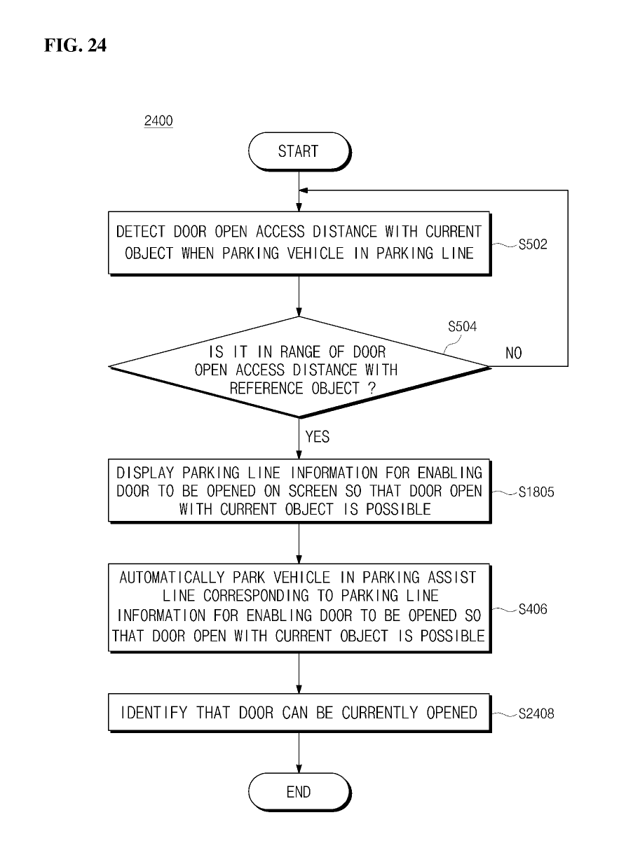

Hereinafter, a parking assist method for assisting parking using the parking assist apparatus 2200 in accordance with the seventh embodiment of the present invention will be described in detail with reference to FIGS. 23 and 24.

FIG. 23 is a flowchart showing a parking assist method of a parking assist apparatus in accordance with a seventh embodiment of the present invention, and FIG. 24 is a flowchart showing an example of a parking assist method of a parking assist apparatus in accordance with a seventh embodiment of the present invention.

Referring to FIGS. 23 and 24, parking assist methods 2300 and 2400 of the parking assist apparatus (2200 of FIG. 22) in accordance with the seventh embodiment of the present invention respectively includes detecting operations S402 and S502, determining operations S404 and S504, displaying operations S1705 and S1805, and parking operation S406 in the same manner as in the parking assist methods 1700 and 1800 of FIGS. 17 and 18 of the parking assist apparatus 1500 of FIG. 15 in accordance with the fifth embodiment of the present invention.

Functions of operations included in the parking assist methods 2300 and 2400 of the parking assist apparatus (2200 of FIG. 22) in accordance with the seventh embodiment of the present invention and an organic connective relationship therebetween are the same as the functions of operations included in the parking assist method (1700 and 1800 of FIGS. 17 and 18) of the parking assist apparatus (1500 of FIG. 15) in accordance with the fifth embodiment of the present invention and the organic connective relationship therebetween, and thus additional description thereof will be omitted.

Here, the parking assist methods 2300 and 2400 of the parking assist apparatus (2200 of FIG. 22) in accordance with the seventh embodiment of the present invention may further include fourth identifying operations S2308 and S2408 after parking operation S406, respectively.

That is, in the fourth identifying operations S2308 and S2408, when parking of the vehicle (V1 of FIG. 2) close to the parking assist line (PL1 of FIG. 16) corresponding to the parking line information (S of FIG. 16) for enabling the door to be opened may be completed based on the intention of the driver in accordance with the control of the control unit (104 of FIG. 22) by the parking operation unit (108 of FIG. 22), the fourth identification unit (2218 of FIG. 22) identifies that the door can be currently opened.

In this manner, the parking assist methods 2300 and 2400 of the parking assist apparatus 2200 in accordance with the seventh embodiment of the present invention includes the detection unit 102, the control unit 104, the determination unit 106, the display unit 1516, the parking operation unit 108, and the fourth identification unit 2218 to thereby perform, detecting operations S402 and S502, determining operations S404 and S504, displaying operations S1705 and S1805, parking operation S406, and fourth identifying operations S2308 and S2408, respectively.

Thus, in the parking assist apparatus 2200 and the parking assist methods 2300 and 2400 thereof in accordance with the seventh embodiment of the present invention, door open with the current object V2 is possible after parking the vehicle, and therefore damage to the door unit of the vehicle V1 may be prevented in advance, thereby suppressing an increase in maintenance costs.

In addition, in the parking assist apparatus 2200 in accordance with the seventh embodiment of the present invention and the parking assist methods 2300 and 2400 thereof, door open with the current object V2 is possible after parking the vehicle, thereby providing convenience to a passenger when the passenger gets out of the vehicle.

In addition, in the parking assist apparatus 2200 in accordance with the seventh embodiment of the present invention and the parking assist methods 2300 and 2400 thereof, when parking of the vehicle V1 close to the parking assist line PL1 corresponding to the parking line information S for enabling the door to be opened is completed based on the intention of the driver in accordance with the control of the control unit, it may be identified that the door can be currently opened.

Accordingly, in the parking assist apparatus 2200 in accordance with the seventh embodiment of the present invention and the parking assist method 2300 and 2400 thereof, a passenger may recognize that the door can be currently opened.

Thus, the parking assist apparatus 2200 and the parking assist methods 2300 and 2400 in accordance with the seventh embodiment of the present invention may reduce the excessive operation frequency of the door unit, and therefore the damage to the door unit of the vehicle V1 may be prevented in advance, thereby further suppressing the increase in the maintenance costs.

As is apparent from the above description, the parking assist apparatus and the parking assist method thereof in accordance with one embodiment of the present invention may obtain the following effects.

First, door open with the current object is possible after parking the vehicle, thereby suppressing an increase in maintenance costs by preventing damage to the door unit of the vehicle in advance.

Second, door open with the current object is possible after parking the vehicle, thereby providing convenience to a passenger when the passenger gets out of the vehicle.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A parking assist apparatus comprising:
a detection unit that detects access information on door open with a current object provided at a parking line when parking a vehicle at the parking line;
a control unit that receives the access information on door open with the current object detected in the detection unit, and includes a range of access information on door open with a reference object set in advance and parking assist line information for enabling a door of the vehicle to be opened;
a determination unit that determines whether the access information on door open with the current object detected in the detection unit is in the range of access information on door open with the reference object in accordance with control of the control unit; and
a parking operation unit that automatically parks the vehicle at a parking assist line corresponding to parking line information for enabling the door of the vehicle to be opened in accordance with the control of the control unit so that door open with the current object is possible, when it is determined in the determination unit that the access information on door open with the current object is in the range of access information on door open with the reference object.

2. A parking assist apparatus comprising:
a detection unit that detects access information on door open with a current object provided at a parking line when parking a vehicle at the parking line;
a control unit that receives the access information on door open with the current object detected in the detection unit, and includes a range of access information on door open with a reference object set in advance and parking assist line information for enabling a door of the vehicle to be opened;
a determination unit that determines whether the access information on door open with the current object detected in the detection unit is in the range of access information on door open with the reference object in accordance with control of the control unit;
a display unit that displays parking line information for enabling a door of the vehicle to be opened on a screen in accordance with the control of the control unit so that door open with the current object is possible, when it is determined in the determination unit that the access information on door open with the current object is in the range of access information on door open with the reference object; and
a parking operation unit that identifies the parking line information for enabling the door to be opened displayed in the display unit, and parks the vehicle close to a parking assist line corresponding to the parking line information for enabling the door to be opened in accordance with the control of the control unit based on an intention of a driver.

3. The parking assist apparatus according to claim 1, wherein the determination unit determines whether a door open access distance with the current object corresponding to the access information on door open with the current object is in a range of a door open access distance with the reference object corresponding to the range of access information on door open with the reference object in accordance with the control of the control unit.

4. The parking assist apparatus according to claim 2, wherein the determination unit determines whether a door open access distance with the current object corresponding to the access information on door open with the current object is in a range of a door open access distance with the reference object corresponding to the range of access information on door open with the reference object in accordance with the control of the control unit.

5. The parking assist apparatus according to claim 1, further comprising:
a first identification unit that identifies that the door cannot be currently opened when it is determined in the determination unit that the access information on door open with the current object is in the range of access information on door open with the reference object.

6. The parking assist apparatus according to claim 2, further comprising:
a first identification unit that identifies that the door cannot be currently opened when it is determined in the determination unit that the access information on door open with the current object is in the range of access information on door open with the reference object.

7. The parking assist apparatus according to claim 1, further comprising:
a second identification unit that identifies that the vehicle is automatically parked at the parking assist line corresponding to the parking line information for enabling the door to be opened when it is determined in the determination unit that the access information on door open with the current object is in the range of access information on door open with the reference object.

8. The parking assist apparatus according to claim 1, further comprising:
a third identification unit that identifies that the door can be currently opened when parking of the vehicle at the parking assist line corresponding to the parking line information for enabling the door to be opened is automatically completed in accordance with the control of the control unit by the parking operation unit.

9. The parking assist apparatus according to claim 2, further comprising:
a fourth identification unit that identifies that the door can be currently opened when parking of the vehicle close to the parking assist line corresponding to the parking line information for enabling the door to be opened is completed in accordance with the control of the control unit based on the intention of the driver by the parking operation unit.

10. A parking assist method comprising:
detecting, by a detection unit, access information on door open with a current object provided at a parking line when parking a vehicle at the parking line;
determining, by a determination unit, whether the access information on door open with the current object detected by the detection unit is in a range of access information on door open with a reference object set in a control unit in accordance with control of the control unit; and
automatically parking, by a parking operation unit, the vehicle at a parking assist line corresponding to parking line information for enabling a door of the vehicle to be opened in accordance with the control of the control unit so that door open with the current object is possible, when it is determined in the determination unit that the access information on door open with the current object is in the range of access information on door open with the reference object.

11. A parking assist method comprising:
detecting, by a detection unit, access information on door open with a current object provided at a parking line when parking a vehicle at the parking line;
determining, by a determination unit, whether the access information on door open with the current object detected by the detection unit is in a range of access information on door open with a reference object set in a control unit in accordance with control of the control unit;
displaying, by a display unit, parking line information for enabling a door of the vehicle to be opened on a screen in accordance with the control of the control unit so that door open with the current object is possible, when it is determined in the determination unit that the access information on door open with the current object is in the range of access information on door open with the reference object; and
identifying, a parking operation unit, the parking line information for enabling the door to be opened displayed in the display unit, and parking the vehicle close to a parking assist line corresponding to the parking line information for enabling the door to be opened in accordance with the control of the control unit based on an intention of a driver.

12. The parking assist method according to claim 10, wherein the determining includes determining, by the determination unit, whether a door open access distance with the current object corresponding to the access information on door open with the current object is in a range of a door open access distance with the reference object corresponding to the range of access information on door open with the reference object in accordance with the control of the control unit.

13. The parking assist method according to claim 11, wherein the determining includes determining, by the determination unit, whether a door open access distance with the current object corresponding to the access information on door open with the current object is in a range of a door open access distance with the reference object corresponding to the range of access information on door open with the reference object in accordance with the control of the control unit.

14. The parking assist method according to claim 10, further comprising after the determining:
identifying, by a first identification unit, that the door cannot be currently opened when it is determined in the determination unit that the access information on door open with the current object is in the range of access information on door open with the reference object.

15. The parking assist method according to claim 11, further comprising after the determining:
identifying, by a first identification unit, that the door cannot be currently opened when it is determined in the determination unit that the access information on door open with the current object is in the range of access information on door open with the reference object.

16. The parking assist method according to claim 10, further comprising after the determining:
identifying, by a second identification unit, that the vehicle is automatically parked at the parking assist line corresponding to the parking line information for enabling the door to be opened when it is determined in the determination unit that the access information on door open with the current object is in the range of access information on door open with the reference object.

17. The parking assist method according to claim 10, further comprising after the automatic parking:
identifying, by a third identification unit, that the door can be currently opened when parking of the vehicle at the parking assist line corresponding to the parking line information for enabling the door to be opened is automatically completed in accordance with the control of the control unit by the parking operation unit.

18. The parking assist method according to claim 11, further comprising after the automatic parking:
identifying, by a fourth identification unit, that the door can be currently opened when parking of the vehicle close to the parking assist line corresponding to the parking line information for enabling the door to be opened is completed in accordance with the control of the control unit based on the intention of the driver by the parking operation unit.
